(19) United States
(12) Patent Application Publication
(10) Pub. No.: US 2024/0127288 A1
(43) Pub. Date: Apr. 18, 2024

(54) ADVERTISEMENT MANAGEMENT SYSTEM

(71) Applicant: LE GRAND CO., LTD., Tokyo (JP)

(72) Inventors: Hiroto IZUMI, Tokyo (JP); Hitomi YAMABE, Tokyo (JP)

(73) Assignee: LE GRAND CO., LTD., Tokyo (JP)

(21) Appl. No.: 18/276,552

(22) PCT Filed: Apr. 26, 2022
(86) PCT No.: PCT/JP2022/018925

§ 371 Date: Aug. 9, 2023

(30) Foreign Application Priority Data
May 19, 2021 (JP) 2021-084626

(51) Int. Cl. G06Q 30/0251

(52) U.S. Cl. CPC G06Q 30/0259; G06Q 30/0252; G06Q 30/0273

(57) ABSTRACT

A system that distributes a suitable advertisement in conjunction with meteorological information such as the weather, temperature, and precipitation amount. In an advertisement management system for requesting distribution of an advertisement from an external advertisement distribution system that distributes the advertisement in a manner of switching depending on a location of a terminal owned by a user who views the advertisement, when the terminal is located in an area in a meteorological state satisfying a meteorological condition set by an advertiser, the advertisement management system requests the advertisement distribution system to distribute or not to distribute an advertisement designated by the advertiser to the terminal, or to change a bidding price serving as a reference for determining one advertisement to be distributed among a plurality of advertisements that are candidates for distribution to the terminal.

### TECHNICAL FIELD

The present invention relates to a technique for distributing a suitable advertisement on the Internet.

### BACKGROUND ART

In recent years, when searching on the Internet, advertisements related to a search keyword are displayed together with search results. When accessing a website or a mobile application, advertisements are displayed on a specific part of a homepage.

In addition, it is statistically or empirically known that a tendency of purchasing a commodity or using a service by a user changes depending on an atmospheric state such as a temperature and weather such as sunny, cloudy, or rainy (hereinafter collectively referred to as a “meteorological state”).

As a related technique, a system has been disclosed that manages movement information and a schedule of a user and distributes advertisement information to a terminal of the user based on the movement information (for example, PTL 1). The system disclosed in this literature also has a function of acquiring meteorological information for an address where the user who receives distribution of an advertisement lives and determining the advertisement to be distributed based on the meteorological information.

### CITATION LIST

### Patent Literature

PTL 1: Japanese Patent No. 6824538

### SUMMARY OF INVENTION

### Technical Problem

Since a meteorological state varies from region to region and changes from time to time, there is a demand for changing the advertisement to be distributed according to a meteorological change.

PTL 1 discloses that an advertisement to be distributed is determined based on meteorological information, but personal information, a schedule, and movement information of a user who is a distribution target of the advertisement (=a person who views the advertisement or a person who is exposed to the advertisement) need to be stored and managed in the system. Storing such personal information in the system is accompanied by a considerable risk in terms of security because serious damage occurs when information leaks.

In addition, according to the technique of PTL 1, when the advertisement is to be distributed, the schedule and movement information of the user as the distribution target is required, and depending on the situation, an input operation or the like for setting the schedule and movement information is to be performed, which is troublesome.

The present invention is to provide a system that distributes a suitable advertisement in conjunction with meteorological information such as the weather, temperature, and precipitation amount.

### Solution to Problem

According to an aspect of the invention, there is provided an advertisement management system for requesting distribution of an advertisement from an external advertisement distribution system that distributes the advertisement in a manner of switching depending on a location of a terminal owned by a user who views the advertisement. When the terminal is located in an area in a meteorological state satisfying a meteorological condition set by an advertiser, the advertisement management system requests the advertisement distribution system to distribute or not to distribute an advertisement designated by the advertiser to the terminal, or to change a bidding price serving as a reference for determining one advertisement to be distributed among a plurality of advertisements that are candidates for distribution to the terminal.

According to another aspect of the invention, there is provided an advertisement management system for requesting distribution of an advertisement to a terminal owned by a user who views the advertisement, from an external advertisement distribution system distributes the advertisement in a switching manner. When a predetermined place set by an advertiser is in a meteorological state satisfying a meteorological condition set by the advertiser, the advertisement management system requests the advertisement distribution system to distribute or not to distribute an advertisement designated by the advertiser to a region set by the advertiser, or to change a bidding price serving as a reference for determining one advertisement to be distributed among a plurality of advertisements that are candidates for distribution to the terminal.

### Advantageous Effects of Invention

According to the invention, it is possible to distribute a suitable advertisement according to meteorological information.

### BRIEF DESCRIPTION OF DRAWINGS

FIG. 1 is a diagram showing an application case of an advertisement management system according to an embodiment.

FIG. 2 is a diagram showing a system configuration example according to the embodiment.

FIG. 3 is a diagram showing an operation example of condition setting processing according to the embodiment.

FIG. 4 is a diagram showing an operation example of advertisement request processing according to the embodiment.

FIG. 5 is a flowchart showing an operation example for displaying an advertisement (campaign) list according to the embodiment.

FIG. 6 is a diagram showing screen transitions up to display of the advertisement (campaign) list according to the embodiment.

FIG. 7 is a diagram showing an advertisement (campaign) registration screen according to the embodiment.

FIG. 8 is a flowchart showing an operation example for setting a target place and a meteorological condition according to the embodiment.

FIG. 9 is a diagram showing an example of a screen for setting a meteorological condition according to the embodiment.

FIG. 10 is a diagram showing an example of a screen for setting a meteorological condition according to the embodiment.

FIG. 11 is a diagram showing an example of a screen for setting a meteorological condition according to the embodiment.

FIG. 12 is a diagram showing an example of a screen for setting a meteorological condition according to the embodiment.

FIG. 13 is a diagram showing an example of a screen for setting a meteorological condition according to the embodiment.

FIG. 14 is a sequence diagram showing an example of an overall operation of the advertisement request processing according to the embodiment.

FIG. 15 is a sequence diagram showing an example of main operations of the advertisement request processing according to the embodiment.

FIG. 16 is a configuration diagram showing a hardware configuration of a web server according to the embodiment.

### DESCRIPTION OF EMBODIMENTS

An advertisement management system according to an embodiment is a system that cooperates with an external system that provides meteorological information and an external system that distributes advertisements, and that implements advertisement distribution linked to a meteorological state.

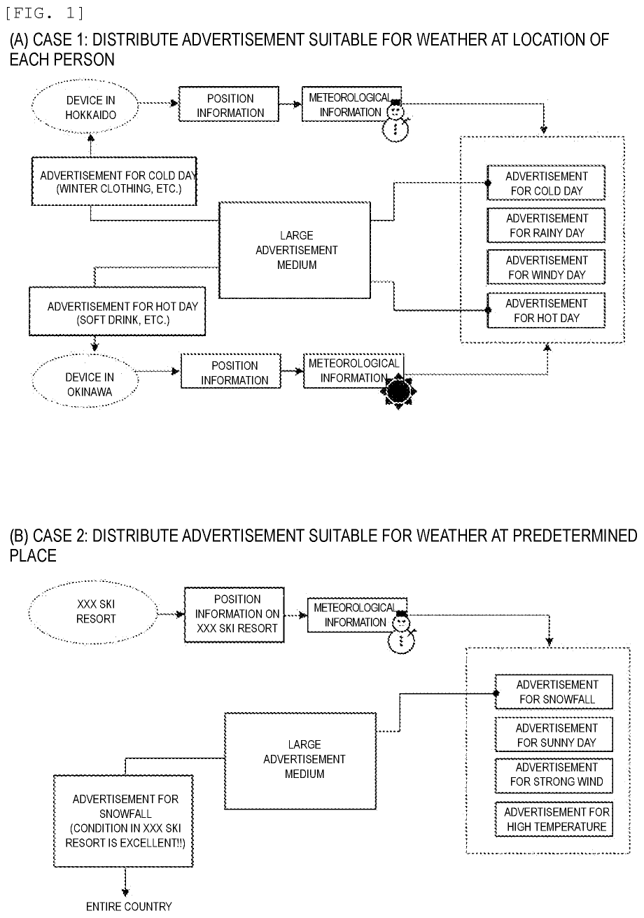

FIG. 1 is a diagram showing an overview of a service provided in an aspect of the embodiment by exemplifying two scenes. Here, there are exemplified Case 1 ((A) of FIG. 1) in which an advertisement suitable for weather at a current location of each person is distributed to the region according to the location, and Case 2 ((B) of FIG. 1) in which an advertisement designated by an advertiser is distributed to the entire country (that is, without limiting the region of the distribution target) according to weather at a specific place such as a leisure facility when a meteorological state at the specific place satisfies a condition.

In Case 1, the current location of a user as an advertisement distribution target (=a person who views the advertisement or a person who is exposed to the advertisement) is identified by GPS information or the like, and the weather, temperature, humidity, and the like at the place are calculated. Actually, these are calculated by requesting a meteorological information providing system, which is an external system, as will be described later. Then, the calculated meteorological information is compared with a meteorological condition set by the advertiser, and a large external advertisement medium is requested to distribute the advertisement designated by the advertiser and satisfying the condition. Here, the “advertiser” refers to an individual, an organization, or a company that desires to post an advertisement, and the large advertisement medium refers to a large company that distributes an advertisement via the Internet, such as an advertisement distribution system provided by GOOGLE (registered trademark) or FACEBOOK (registered trademark).

In Case 1, for example, when a temperature in Hokkaido on this day is below freezing, the advertisement management system according to the embodiment requests the large advertisement medium to distribute an advertisement for a cold day satisfying the condition, such as an advertisement for a heater or winter clothing among commodities handled by the advertiser. According to this request, the large advertisement medium distributes the advertisement for the cold day in Hokkaido as an advertisement of the advertiser.

Similarly, when a user as an advertisement distribution target is in Okinawa, meteorological information such as the weather, temperature, and humidity in Okinawa is calculated by requesting an external meteorological information providing system based on the position information (here, it is assumed that fierce heat is calculated). Then, the advertisement management system according to the embodiment compares the calculated meteorological information with a meteorological condition set by the advertiser, and requests the large advertisement medium to distribute an advertisement satisfying the condition. Here, the large advertisement medium is requested to distribute an advertisement for a hot day, such as an advertisement for an ice-lolly or a soft drink among the commodities handled by the advertiser.

In Case 2, the advertisement management system according to the embodiment requests the large advertisement medium to distribute, to the entire country (that is, without limiting the region), an advertisement corresponding to meteorological information at a specific place designated by the advertiser. As shown in an example of (B) of FIG. 1, when it snows at a specific ski resort, an advertisement is distributed that appeals that the ski resort is in a good condition due to fresh snow and encourages visits to the ski resort.

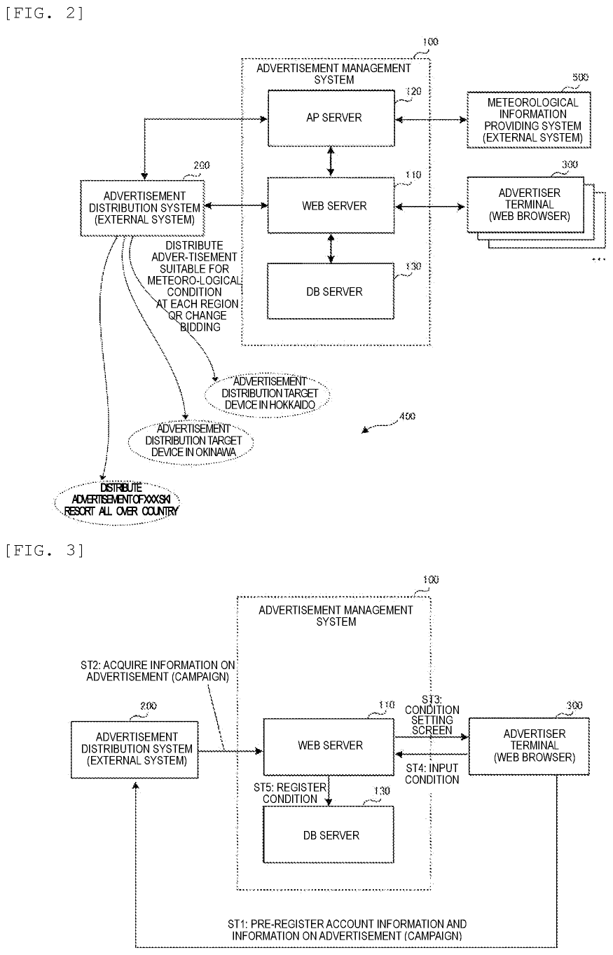

Subsequently, the advertisement management system according to the embodiment will be described. FIG. 2 is a diagram showing an overall configuration example including the advertisement management system according to the embodiment.

An advertisement management system 100 includes one or more computers, and includes at least a web server 110, an AP server 120, and a DB server 130 in the embodiment (a configuration is not limited thereto). The advertisement management system 100 cooperates with an advertisement distribution system 200, which is an external cloud system, and a meteorological information providing system 500, which is an external cloud system, and distributes a suitable advertisement according to a location of a user as an advertisement distribution target or a meteorological state at a predetermined place designated by an advertiser. In the following description, the advertisement distribution system 200 is assumed to be an advertisement distribution system under GOOGLE, but FACEBOOK or another advertisement distribution system may be used. These advertisement distribution systems may be selectable.

An advertisement distribution target device 400 is an information communication terminal that can be connected to the Internet, such as a PC, a smart phone, or a tablet. The advertisement distribution target device 400 receives an advertisement distributed from the advertisement distribution system 200 and displays the advertisement when accessing a website, searching with a search engine, or using a mobile application. The user who owns the advertisement distribution target device 400 can view the displayed advertisement and, if interested in the advertisement, can know details of the advertisement by pressing an advertisement image, for example.

An advertiser terminal 300 is a PC, a tablet, or the like owned by the advertiser, and is equipped with a web browser. The advertiser terminal 300 accesses the web server 110 of the advertisement management system 100 and sets information on a target place to determine meteorological information (hereinafter, simply referred to as a “target place”), a meteorological condition, and the like (details will be described later). Similarly, in the following description, the “target place” does not indicate a distribution target to which an advertisement is to be distributed, but simply means a place to determine meteorological information.

The web server 110 waits at a prescribed port number such as a port No. 80 (HTTP) or a port No. 443 (HTTPS), and returns a response (content) when receiving request information (HTTP GET) from the advertiser terminal 300. In the embodiment, the web server 110 transmits a screen (HTML or CSS) for setting a target place or a meteorological condition to the advertiser terminal 300, and the advertiser terminal 300 displays the screen (this series of operations is simply referred to as “display”).

The web server 110 incorporates a web server program and a batch logic (program) for causing the AP server 120 to periodically execute processing.

The DB server 130 is constructed with a relational database in which target places, meteorological conditions, and the like input via a display screen of the web server 110 are registered in association with one another. Information actually registered will be described later together with the description of an operation flowchart.

The AP server 120 is mainly a server that operates when receiving an execution instruction from the batch logic of the web server 110. The AP server 120 calculates meteorological information at each place in cooperation with the meteorological information providing system 500, compares the meteorological information with the meteorological condition set by the advertiser, and determines whether the meteorological condition is satisfied. Then, when the meteorological information satisfies the meteorological condition, the AP server 120 requests the advertisement distribution system 200 to distribute or not to distribute an advertisement, or to change a bidding price.

Subsequently, an operation of the advertisement management system. 100 will be described. The operation of the advertisement management system 100 can be roughly divided into two phases. A first phase is a “condition setting phase” in which the advertiser sets a meteorological condition or the like and registers the meteorological condition or the like in the DB server 130, and a second phase is an “advertisement request phase” in which the advertisement distribution system 200 is requested to distribute an advertisement designated by the advertiser to a place satisfying the meteorological condition.

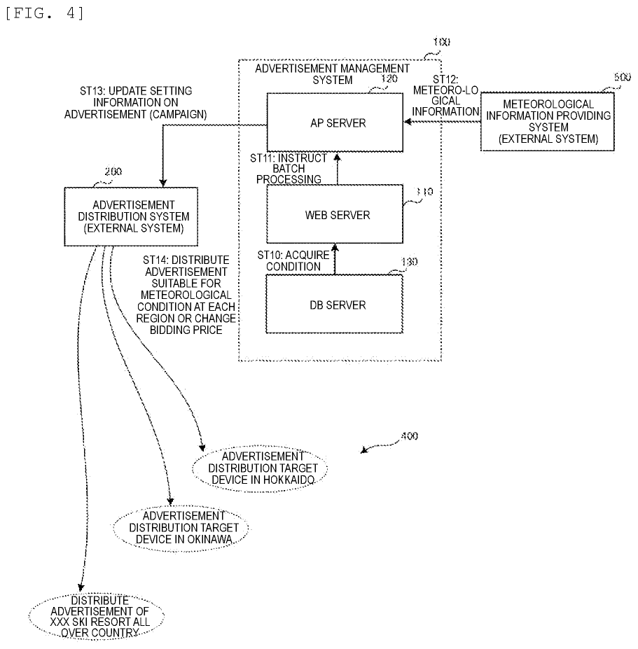

FIG. 3 is a diagram showing the operation in the “condition setting phase”. First, before using the advertisement management system 100, the advertiser registers in the advertisement distribution system 200 identification information thereof and data on the advertisement desired to be distributed. At this time, in the embodiment, the following information is pre-registered in the advertisement distribution system 200 (ST1).

“Customer ID” and “advertisement account” are registered as account information for identifying the advertiser. The customer ID is unique information used for identifying an advertisement account, and is a unique number assigned by the advertisement distribution system 200. The advertisement account is an account for managing an advertisement to be distributed.

The advertiser registers one or more pieces of advertisement data managed under the advertisement account. Here, the “advertisement data” is content data such as advertisement identification information (hereinafter referred to as a “campaign ID”) for uniquely identifying an advertisement, an advertisement image, and a search keyword for displaying the advertisement. Hereinafter, “advertisement” may be referred to as “campaign”.

The identification information such as the “customer ID” and the “advertisement account”, and the advertisement data registered here are, after all, based on the specification of the advertisement distribution system 200 (the specification of GOOGLE), and thus are not limited thereto (FACEBOOK and the like have different account management). In the embodiment, at least the advertisement (campaign) registered in the advertisement distribution system 200 may be identified from the advertisement management system 100.

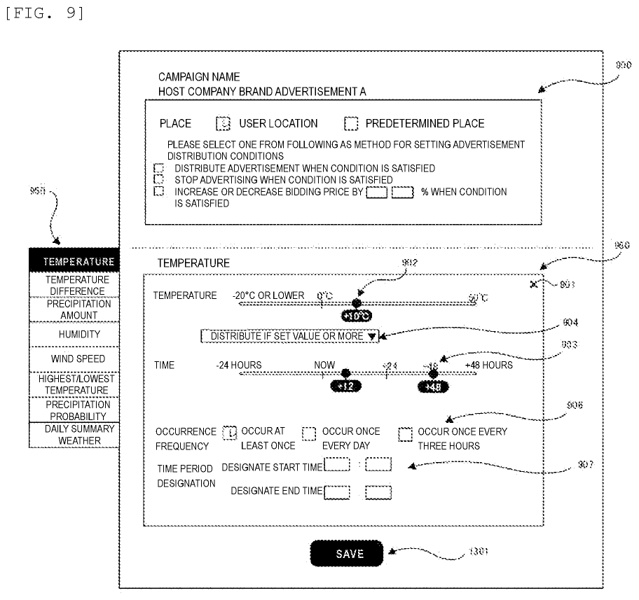

On a premise that the account information and the advertisement (campaign) are pre-registered, when the web server 110 is accessed from the advertiser terminal 300, the web server 110 acquires, from the advertisement distribution system 200, information on an advertisement (campaign) desired to be managed by the advertisement management system 100 (ST2). Then, the web server 110 displays a screen for setting a target place and a meteorological condition for the campaign (screens in FIGS. 9 to 13 to be described later) on the advertiser terminal 300, which is an access source (ST3). The advertiser inputs a condition based on the setting screen displayed on the advertiser terminal 300 (ST4), and the web server 110 receives the condition and registers the condition in the DB server 130 in association with campaign identification information (ST5). The “campaign identification information” is described here as a campaign ID, but may be any information for uniquely identifying a campaign by combining various data.

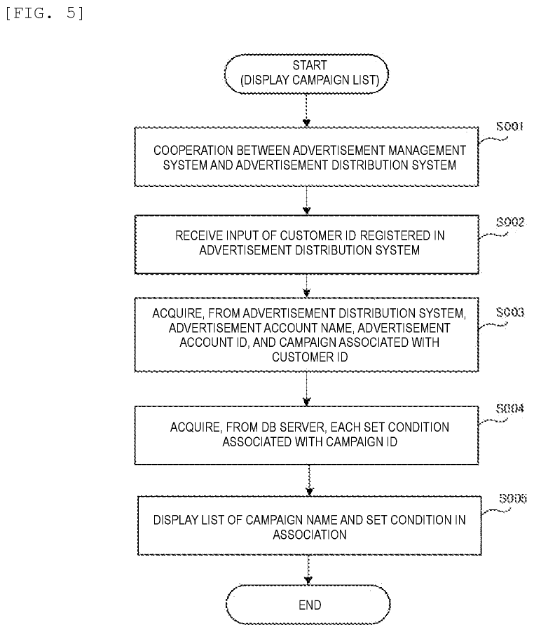

FIG. 4 is a diagram showing the operation in the “advertisement request phase”. The “advertisement request phase” is executed by the batch logic of the web server 110, once an hour, for example.

The web server 110 acquires a record including a campaign ID, a target place, a meteorological condition, and the like registered in the DB server 130 (ST10). Then, the web server 110 transmits the information to the AP server 120 and instructs the AP server 120 to execute batch processing (ST11).

The AP server 120 acquires meteorological information at each target place from the meteorological information providing system 500 in conjunction with or asynchronously with the execution instruction for the batch processing (ST12). Each place acquired here has a degree of granularity that allows the advertisement distribution system 200 to switch advertisements. It is assumed that the advertisement distribution system 200 according to the embodiment divides the whole of Japan into 991 places (in the case of GOOGLE) and distributes advertisements in a manner of switching depending on the place. The granularity of this place is not limited thereto, and depends on the specification of the advertisement distribution system 200. The AP server 120 transmits the latitude and longitude of each of the 991 places to the meteorological information providing system 500, and acquires meteorological information at each place. The meteorological information providing system 500 divides the whole of Japan into 1-km squares (approximately 370,000 areas), stores meteorological information for each area, selects the latitude and longitude of each of the 991 places from the squares, and returns the meteorological information. Details of types of the meteorological information acquired here (weather, temperature, and the like) will be described later together with the description of the operation flowchart. When not all of the 991 places are distribution target places and only some of the places are distribution targets, the AP server 120 requests the meteorological information providing system 500 only for the meteorological information at the distribution target places.

In Case 1 shown in (A) of FIG. 1, the AP server 120 selects a place satisfying a meteorological condition set by the advertiser from the acquired 991 places, and selects the place as an advertisement distribution target region. Then, the AP server 120 at least associates the place with a campaign ID and instructs the advertisement distribution system 200 to update setting (ST13). In ST13, the AP server 120 requests the advertisement distribution system to distribute or not to distribute an advertisement designated by the advertiser, or to change a bidding price.

The advertisement distribution system 200 distributes the advertisement (campaign) based on position information (GPS information or the like) from the advertisement distribution target device 400 (ST14).

In steps ST13 and ST14, the advertisement (campaign) is distributed to the place satisfying the meteorological condition preset by the advertiser.

On the other hand, in Case 2 shown in (B) of FIG. 1, the AP server 120 determines whether a meteorological state at the latitude and longitude satisfies the meteorological condition set by the advertiser. When the condition is satisfied, the AP server 120 requests the advertisement distribution system to distribute or not to distribute the advertisement designated by the advertiser, or to change the bidding price (ST13).

The advertisement distribution system 200 distributes the advertisement (campaign) all over the country without limiting the distribution target region (ST14).

Some of the advertisement distribution systems 200 adopt an auction format in which an advertisement to be distributed is ranked based on a bidding price or the like and an advertisement to be actually distributed is determined based on the ranking. In this case, only when the advertiser wins in the auction, an advertisement of the advertiser is to be distributed at the place. Therefore, when such an auction format is adopted, distribution is not guaranteed, and if the advertiser loses, the advertisement of the advertiser is not to be distributed, and an advertisement of another company is to be distributed. The advertisement distribution system. 200 according to the embodiment is a system in which the advertiser can designate a bidding price for advertisement viewing by a user, and is a system that adopts an auction format in which one advertisement is determined and distributed among advertisements as distribution candidates based on the bidding price. The embodiment is also applicable to an advertisement distribution system that does not use the auction format.

In the embodiment, when meteorological information at a location of the user or in predetermined weather satisfies a preset meteorological condition, there are two behavior patterns: (1) to turn on or off advertisement distribution, or (2) to change a bidding price, and which one is to be selected is set by the advertiser using this system in ST4.

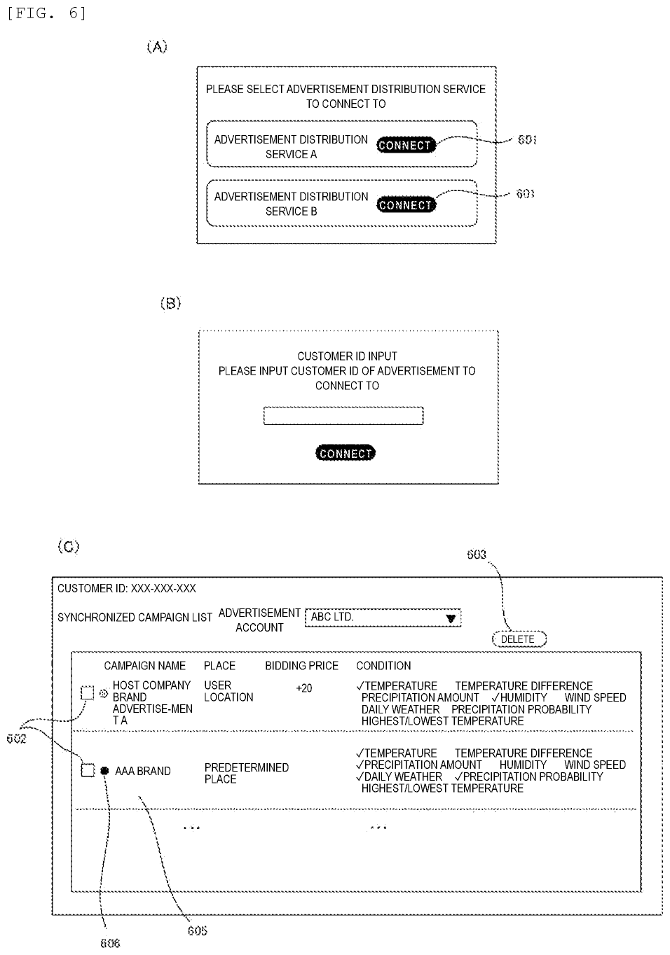

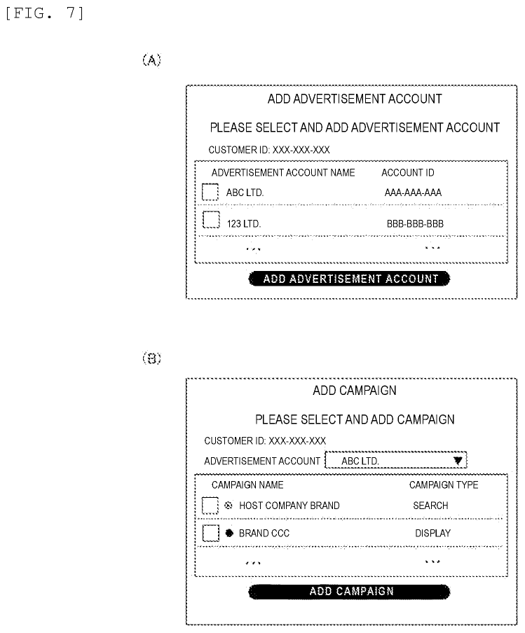

Subsequently, the operation in the “condition setting phase” shown in FIG. 3 will be described using a flowchart and a display screen. FIG. 5 is a flowchart up to displaying an advertisement (campaign) list, and FIG. 6 shows examples of a display screen during the processing.

First, when the web server 110 receives access from the advertiser terminal 300 via the web browser, the web server 110 displays a screen shown in (A) of FIG. 6 and executes processing of cooperation between the advertisement management system 100 and the advertisement distribution system 200 (S001). The advertiser who operates the advertiser terminal 300 selects an advertisement distribution service to be connected by pressing one of the buttons 601 shown in (A) of FIG. 6.

When the button 601 for the advertisement distribution system 200 (here, a button for “advertisement distribution service A”) is pressed, a management screen (not shown) provided by the advertisement distribution system 200 is displayed, and authentication processing for a customer ID is executed as log-in processing for the advertisement distribution system 200 via the screen. Thereafter, the web server 110 displays a screen in (B) of FIG. 6 on the advertiser terminal 300, and waits for input of the same customer ID as in S001 (S002).

When the customer ID is input, the web server 110 acquires, from the advertisement distribution system 200, an advertisement account name, an advertisement account ID, and a campaign (including a campaign name and a campaign ID) associated with the customer ID (S003). Then, the web server 110 refers to the DB server 130, acquires set information associated with the campaign ID (a target place, a bidding price variation rate, a meteorological condition, and the like to be described later) (S004), and displays a list shown in (C) of FIG. 6 (S005). In the list display shown in (C) of FIG. 6, when a check box 602 is selected and then a delete button 603 is pressed, the selected campaign is deleted. When a campaign name 605 is clicked, the processing transitions to a meteorological condition setting operation (operation shown in FIG. 8 to be described later) for the campaign.

An icon 606 indicates whether the campaign is valid or invalid, and operating the icon 606 switches between valid and invalid. A solid circle mark indicates valid, and a pause mark indicates invalid.

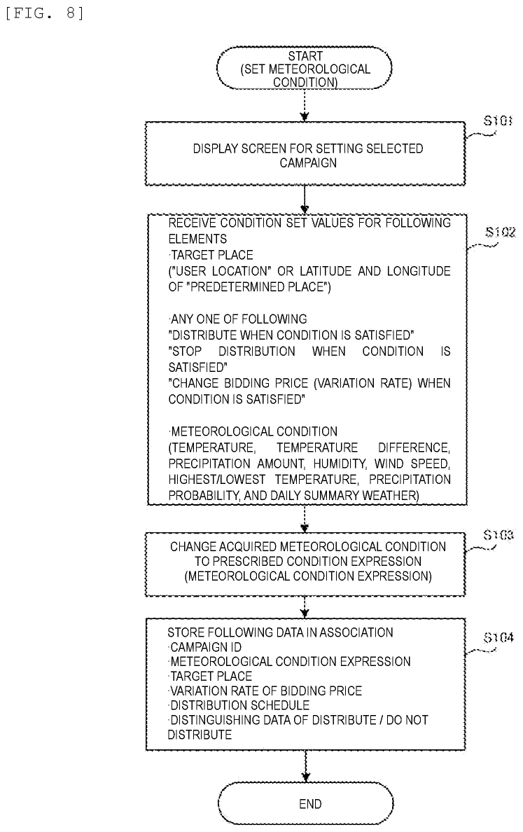

When no campaign is registered in the advertisement management system 100, screens shown in FIG. 7 is displayed. That is, the web server 110 acquires a list of advertisement accounts associated with the customer ID from the advertisement distribution system 200 and displays the list (see (A) of FIG. 7). Then, the web server 110 displays a list of campaign names of the advertisement account selected from the list (see (B) of FIG. 7). When a campaign is selected on a screen in (B) of FIG. 7, a condition setting operation for the campaign (an operation shown in FIG. 8 to be described below) continues.

FIG. 8 is a flowchart showing a condition setting operation for an advertisement (campaign). The web server 110 displays a screen for setting a target place and a meteorological condition for the selected advertisement (campaign) (S101), and receives a condition value for each element from the advertiser (S102).

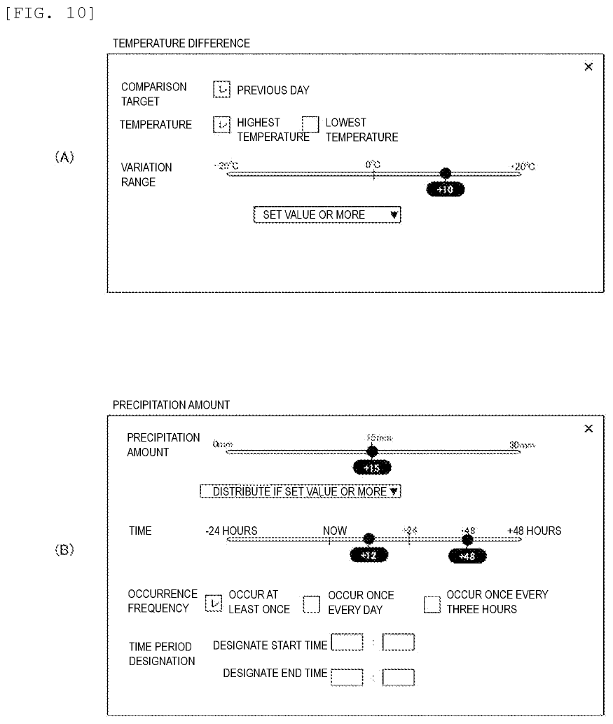

The condition setting screen displayed in S101 is shown in FIGS. 9 to 13. In the condition setting screen according to the embodiment, an upper area 900 and a save button 1301 shown in FIG. 9 are always displayed. When a tab 950 is operated, a lower area 960 is switched to setting screens of “temperature”, “temperature difference”, “precipitation amount”, “humidity”, “wind speed”, “highest/lowest temperature”, “precipitation probability”, and “daily summary weather” (screens in FIGS. 9 and 10 to (A) of 13).

The upper area 900 in FIG. 9 is an item for setting an overall behavior of a target campaign. The advertiser selects whether a distribution target of the advertisement is a “user location” (second place information) or a “predetermined place” (first place information) via a screen of the upper area 900 in FIG. 9. In a case of the “user location”, an operation of Case 1 shown in (A) of FIG. 1 is performed, and the advertisement corresponding to a position (a value of GPS or the like) of the advertisement distribution target device 400 is distributed. On the other hand, in a case of the “predetermined place”, an operation of Case 2 shown in (B) of FIG. 1 is performed, and the advertisement is distributed or a bidding price is changed according to meteorological information at the predetermined place. When the “predetermined place” is selected, it is necessary to further identify a position of the place, and thus the web server 110 displays an input screen for the latitude and longitude of the place or a prefecture name of the place, such that the place corresponding to the input latitude and longitude or the prefecture can be confirmed on the map.

In the upper area 900, it is possible to set any one of distribution of an advertisement when a meteorological condition to be described below is satisfied, stop of distribution when a meteorological condition is satisfied, and change of a bidding price when a meteorological condition is satisfied.

In FIG. 9, the advertiser can set a bidding price variation rate within a range of −90% to +100% in increments of 10% (numerical values of the range and the increments are not limited thereto). Here, for example, when the bidding price increases by +20%, an advertisement tends to be ranked higher than an advertisement of another company in the auction, and the advertisement is more likely to be distributed accordingly. Along with this, an advertisement cost to be paid by the advertiser to the advertisement distribution system 200 is also highly likely to increase. However, the advertisement cost to be actually paid is determined by the advertisement distribution system 200 based on an auction situation at the time of advertisement distribution.

Conversely, for example, when the bidding price decreases by −20%, the rank tends to be lower even in the auction in the advertisement distribution system 200, and thus the advertisement is less likely to be distributed. That is, when a commodity is not likely to sell even if the advertisement is distributed, for example, an ice cream is advertised in a cold place, cost effectiveness of the advertisement will be low, and thus the possibility of distribution can be reduced by setting the bidding price to a negative value. Since the advertisement cost is also highly likely to be reduced, a cost for distribution can be reduced even if the advertisement is distributed.

Next, setting items related to the temperature displayed in the lower area 960 of FIG. 9 will be described. When a mark 901 shown in this frame is selected, a search expression that does not consider or evaluate the temperature is generated (the same applies to each meteorological condition below).

In setting the temperature, the advertiser can set a threshold of the temperature by operating a slider 902, and can designate time by operating a slider 903. A condition can be designated by operating a pull-down menu 904. With this designation, it is possible to set “distribution of an advertisement (or stop of distribution, or change of a bidding price) when a temperature satisfies a prescribed condition within a designated period”.

In a field 906, it is possible to designate occurrence frequency of a temperature state, such as “occur at least once”, “occur once every day”, and “occur once every three hours”. In a field 907, it is also possible to designate an occurrence time period by time point.

A set value of the temperature may be designated in a range of 30° C. to 40° C., for example. In an example in FIG. 9, one set value is taken as a threshold, and this threshold value is used as a determination reference, so one data point is used. However, when a range is to be designated, two data points, an upper limit and a lower limit, are to be designated.

In the pull-down menu 904, any one of a set value or more, a set value or less, within a set range, and out of a set range can be selected as a condition.

In setting the temperature difference shown in (A) of FIG. 10, it is possible to set distribution (or non-distribution, bidding price change) when a difference between a highest temperature on the day and a highest temperature on the previous day is the set value or more, the set value or less, or within the set range or out of the set range. The same setting can be made for a lowest temperature.

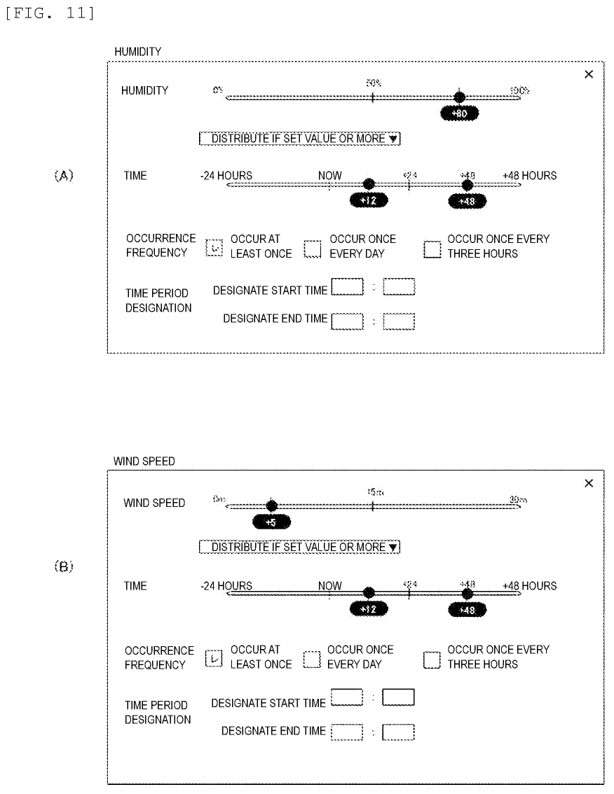

The precipitation amount shown in (B) of FIG. 10, the humidity shown in (A) of FIG. 11, and the wind speed shown in (B) of FIG. 11 are the same as those in setting the “temperature” described above, and thus the description thereof will be omitted.

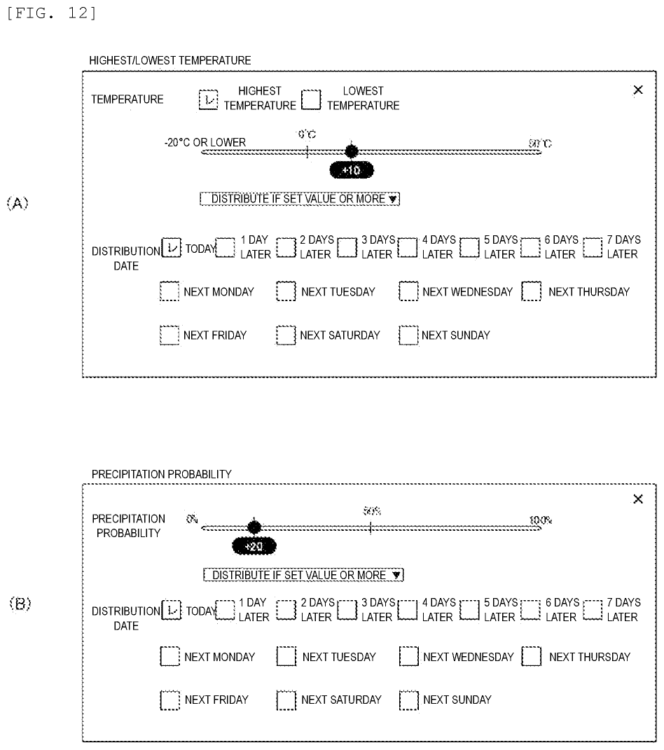

In setting the highest/lowest temperature shown in (A) of FIG. 12, either the highest temperature or the lowest temperature is designated, and the set value (threshold) or the range of the highest temperature or the lowest temperature is designated. Then, the advertiser designates (regarding the highest temperature) “distribute (or do not distribute, change bidding price) if set value or more”, “distribute (or do not distribute, change bidding price) if set value or less”, “distribute (or do not distribute, change bidding price) if within set range”, and “distribute (or do not distribute, change bidding price) if out of set range” using the pull-down menu, and designates a distribution date. The distribution date can be designated from “today” to “seven days later”, and a day of the week can also be designated. The “distribution date” set here means that, for example, an advertisement is to be distributed (or not to be distributed, or a bidding price is to be changed) “if sunny three days later” or “if sunny next Sunday”.

The precipitation probability shown in (B) of FIG. 12 also has the same setting content as the highest/lowest temperature.

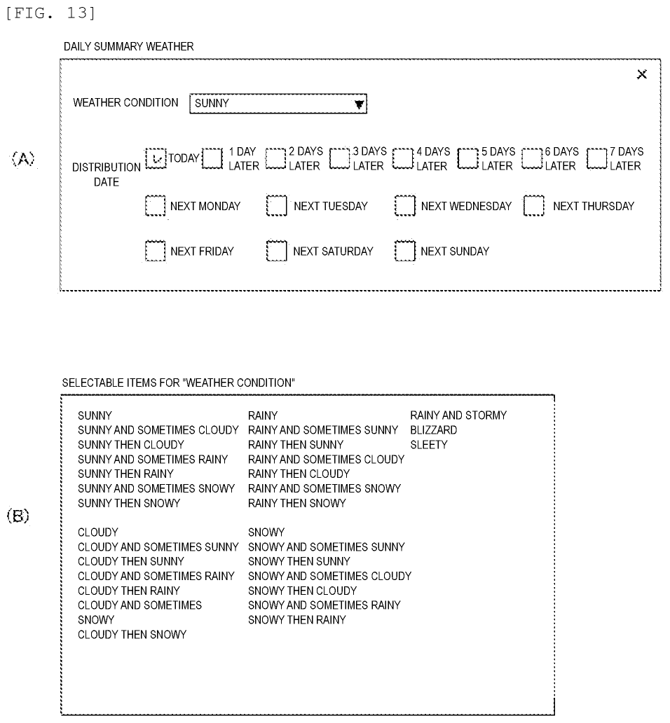

Weather can be designated in “daily summary weather” shown in (A) of FIG. 13. A list of weather that can be designated here is shown in (B) of FIG. 13. In the embodiment, it is possible to designate not only “sunny”, “cloudy”, “rainy”, and “snowy”, but also a combination such as “sunny and sometimes cloudy” and “sunny then rainy”. It is also possible to designate special weather such as “rainy and stormy”, “blizzard”, and “sleety”.

In addition, similarly to the highest/lowest temperature, the precipitation probability, and the like, it is possible to designate a distribution date such as a day or a day of the week from “today” to “seven days later”.

Finally, the advertiser presses the save button 1301 shown in (A) of FIG. 9. Triggered by pressing the button, the web server 110 links each of meteorological conditions described in FIGS. 9 to (A) of 13 by AND, and converts the meteorological conditions into a meteorological condition expression described in text data, for example (S103). This meteorological condition expression is assumed to be readable and analyzable in the processing of S406 to be described later. Although the meteorological conditions are linked by AND here, the meteorological conditions may be linked by OR or may be switchable between AND/OR.

The DB server 130 registers a campaign ID, a meteorological condition expression, a target place, distinguishing data (=distinguishing information), and a bidding price variation rate in association with one another (S104). The distinguishing data is flag data for distinguishing to distribute or not to distribute (=stop distribution), or to change a bidding price, and is selected in the upper area 900 shown in FIG. 9. The bidding price variation rate is undefined when the bidding price is not set to be changed.

Regarding the target place, in a case of the “predetermined place”, the latitude, longitude, or prefecture of the place is given as a target place to acquire meteorological information, and in a case of the “user location”, all of the 991 places are target places. Therefore, a special value that can be identified is given as the target place.

As described above, the “target place” registered here is not a destination to which an advertisement is distributed, but is simply a place to acquire meteorological information for determining whether a condition is satisfied.

In the case of the “predetermined place”, it is assumed that an advertisement is distributed to the entire country in order to encourage people from all over the country to visit a predetermined place when meteorological information at the predetermined place is good. Therefore, it is determined whether the meteorological information at the predetermined place is good when knowing the meteorological information at the place, and thus the predetermined place is pinpointed and registered as the target place.

On the other hand, in the case of the “user location”, an operation of controlling to or not to distribute an advertisement to users all over the country, or to change a bidding price, is performed according to meteorological states at places of the users. Therefore, since it is necessary to determine whether meteorological information satisfies a condition for each place in the country, it is necessary to know the meteorological information all over the country. Therefore, all of the 991 places in the country are the target places.

Subsequently, the “advertisement request phase” shown in FIG. 4 will be described with reference to a time chart and the like.

In the embodiment, functions are divided into a server process for allocating a job and a worker process for executing the allocated job, and these processes are implemented in the AP server 120. Hereinafter, the server process for allocating the job is referred to as a “job server 120A”, and the worker process for executing the job is referred to as a “job worker 120B”.

In the embodiment, the job worker 120B has a configuration in which a plurality of independent processes, such as five processes, are executed in parallel. The job server 120A allocates a job to an idle worker among the plurality of job workers 120B. By dividing the functions into a plurality of process configurations in this manner, it is possible to easily increase the number of AP servers 120 to distribute a load.

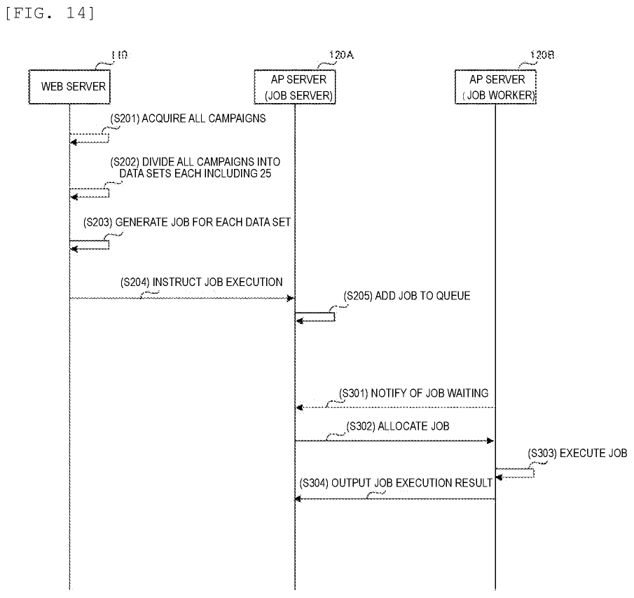

First, an overall operation in the “advertisement request phase” will be described with reference to FIG. 14. In the operation in FIGS. 14, S201 to S205 are one integrated operation, and S301 to S304 are one integrated operation. A group of S201 to S205 and a group of S301 to S304 are asynchronous, and S201 to S205 are operated by the batch logic of the web server 110 and executed every hour.

The web server 110 acquires all records registered in the DB server 130 (records in each of which a campaign ID, a meteorological condition expression, a target place, distinguishing data, and a bidding price variation rate are associated) (S201). The web server 110 divides all the acquired records into units of 25, and creates data sets by bundling each 25 records (S203). The unit here is 25, but is not limited thereto.

Next, the web server 110 generates a job for each data set (S203). Here, the “job” means a group of processing operations, and is, for example, a unit in which a command and parameters (data) used for the command are grouped as one set.

The web server 110 submits the job generated in S203 to the AP server 120, and issues a job execution instruction (S204). The job server 120A of the AP server 120 that receives this adds the submitted job to a waiting queue managed thereby (S205).

When the job worker 120B of the AP server 120 is currently idle and is not executing any job, the job worker 120B notifies the job server 120A of this fact (S301). The job server 120A allocates the job in the waiting queue to the notified job worker 120B by a first-in first-out (FIFO) method (S302).

The job worker 120B executes the job allocated by the job server 120A by a method to be described later (S303), and returns a job execution result to the job server (S304).

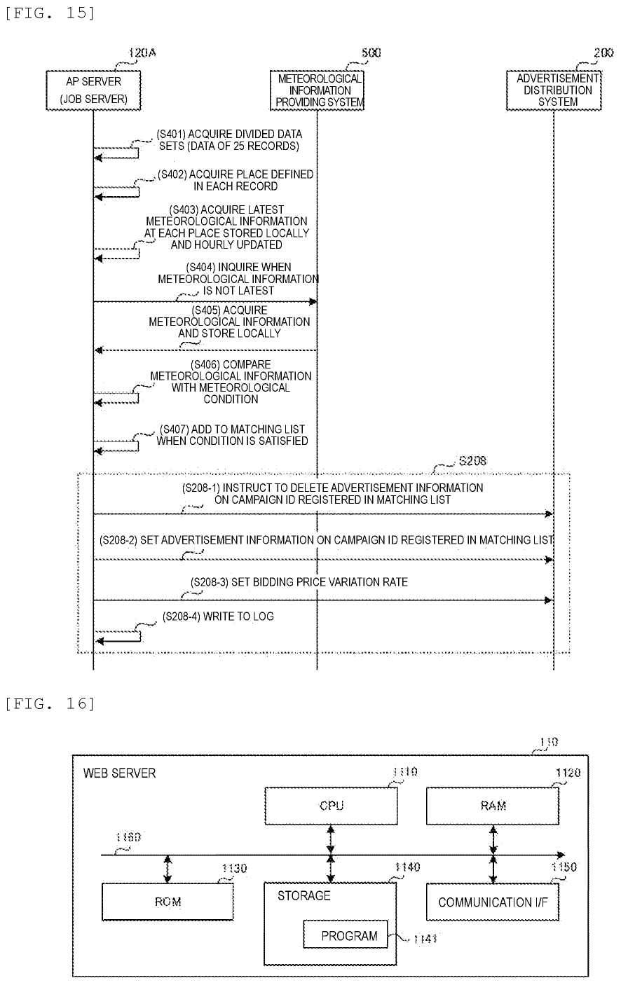

FIG. 15 is a sequence diagram showing job execution shown in S303 in FIG. 14. The job worker 120B operates in cooperation with the meteorological information providing system 500 and the advertisement distribution system 200.

The job worker 120B of the AP server 120 acquires a data set (25 records) allocated by the job server 120A (S401). Then, the job worker 120B acquires a place defined in each record in the data set (S402), and acquires hourly updated meteorological information at each place stored locally in the AP server 120 (in a storage built in or connected to the AP server 120) (S403).

On the other hand, when the locally stored meteorological information was provided over an hour ago, the job worker 120B inquires of the meteorological information providing system 500 (S404). This inquiry may be meteorological information at only a place to be processed this time, or may be meteorological information at a place defined in each of the 25 records. Alternatively, meteorological information at all of the 991 places may be inquired. When the “special value” is given to the target place, meteorological information at all of the 991 places is inquired.

In the embodiment, the job worker 120B transmits an HTTP request (or HTTPS request) to a specific URL under the control of the meteorological information providing system 500 using the latitude and longitude of the target place as parameters. In response, all the following meteorological information at the target place is returned. A type of return data and a range of acquirable dates (particularly, the humidity and precipitation probability cannot be obtained from the previous day) depend on the specification of the meteorological information providing system 500, and are not limited thereto.
Hourly and three-hourly weather, temperature, humidity excluding previous day, wind direction and speed, precipitation amount, and precipitation probability excluding previous day, of previous day, today, one day ahead, and two days ahead.
Daily summary data from previous day to seven days ahead (weather, lowest temperature, highest temperature, daily precipitation probability excluding previous day, and representative values of wind direction and speed).
Differences in lowest temperature from previous day, differences in highest temperature from previous day, and six-hour precipitation probability of today and one day ahead.

The job worker 120B locally stores the returned meteorological information (S405).

The job worker 120B compares the acquired meteorological information with a meteorological condition of each record in data set (S406), and registers the target place in a list when the meteorological information satisfies the meteorological condition (S407). The list is a list in which a campaign ID, a target place, distinguishing data, and a bidding price variation rate are associated with one record, and is referred to as a “matching list” here.

Since operations of S406 and S407 are different between the “user location” and the “predetermined place”, each will be described.

In the case of the “user location”, the job worker 120B compares values of meteorological information at all of the 991 places with the meteorological condition, and finds a place satisfying the meteorological condition among all of the 991 places. Then, the job worker 120B registers the place satisfying the meteorological condition, a campaign ID, distinguishing data, and a bidding price variation rate in the matching list in association with one another. When there are 50 places satisfying the meteorological condition, for example, records for the 50 places are registered in the matching list.

In the case of the “predetermined place”, the job worker 120B acquires meteorological information of the registered latitude and longitude or prefecture from the meteorological information providing system 500 and determines whether the meteorological information satisfies the meteorological condition. Ina case of matching, the job worker 120B registers data indicating distribution to the entire country, a campaign ID, distinguishing data, and a bidding price variation rate in the matching list in association with one another.

Next, the job worker 120B instructs the advertisement distribution system 200 to update the setting related to the advertisement using an application programming interface (API) provided by the advertisement distribution system 200 (S208).

The advertisement distribution system 200 according to the embodiment can set advertisement (campaign) distribution for an advertisement distribution place, a language (Japanese site, English site, or the like), a keyword, a schedule (a day of the week, a time period, or the like for distribution), an interest, concern or a habit of a user, and a bidding price. The job worker 120B issues an instruction to change the distribution place and the bidding price among these.

Subsequently, an internal operation of S208 will be described. The job worker 120B extracts a campaign ID from the matching list and transmits, to the advertisement distribution system 200, an instruction to delete setting of advertisement information associated with the campaign ID (S208-1). Accordingly, setting information on the campaign managed by the advertisement distribution system 200 is temporarily deleted.

Then, the job worker 120B resets a place only for the campaign IDs registered in the matching list having the distinguishing data of “distribute” or “change bidding price” (S208-2). That is, those having the distinguishing data of “do not distribute” are not to be reset, and thus remains deleted and are set to “do not distribute” as a result.

In addition, the job worker 120B changes the bidding price according to the bidding price variation rate for a case where the distinguishing data is “change bidding price” (S208-3). The job worker 120B writes the operation of this series of processing to a log (S208-4).

The operation of S208-1 to S208-3 is a two-stage operation in which the setting is temporarily deleted and new setting is given, but this operation depends on the specification of the advertisement distribution system 200. Therefore, depending on the specification of the API of the advertisement distribution system to be used, the set value can be updated by one operation.

Finally, a hardware configuration example of the web server 110 is shown in FIG. 16. The AP server 120 and the DB server 130 also have the same configuration as that shown in FIG. 16.

The web server 110 includes hardware resources equivalent to those of a general computer. Therefore, a CPU 1110, a RAM 1120, a ROM 1130, a storage 1140, and a communication I/F 1150 are connected via a bus 1160. The communication I/F 1150 constitutes an interface for wired or wireless communication between devices, and is connected to external devices such as the AP server 120 and the DB server 130.

The CPU 1110 is an arithmetic processing unit and controls an overall operation of the web server 110. The RAM 1120 is a volatile storage device, and the ROM 1130 is a nonvolatile storage device. The storage 1140 is a large-capacity storage device (auxiliary storage device) such as an HDD or an SSD.

In this hardware configuration, a program 1141 stored in the ROM 1130 or the storage 1140 is loaded into the RAM 1120, and the CPU 1110 executes the program 1141. This execution constitutes a software control unit including various functional modules.

A storage unit corresponds to the DB server 130, and a meteorological information acquisition unit, a determination unit, and an update requesting unit correspond to the AP server 120 (particularly, the job worker 120B).

In Case 2 in (B) of FIG. 1, the embodiment is described such that when a meteorological state at a specific place such as a leisure facility is good, an advertisement for encouraging visits is distributed all over the country, but may be implemented such that the advertiser sets a distribution target as desired and an advertisement is distributed only to the set region. For example, when the advertiser sets only Hokkaido and Kyushu as distribution targets, the advertisement management system 100 controls advertisement distribution (=turns on or off distribution, or change a bidding price) only for Hokkaido and Kyushu. In this case, it is assumed that the advertiser sets a distribution target region as advertisement data of an advertisement account when pre-registering in the advertisement distribution system 200 in ST1, and the web server 110 of the advertisement management system 100 acquires, from the advertisement distribution system 200, information on the distribution target region as a part of information on the advertisement in ST2. Then, when only some places set by the advertiser are distribution targets, the AP server 120 requests the meteorological information providing system 500 only for meteorological information at places as the distribution targets. The AP server 120 requests the advertisement distribution system 200 to update such that only some places set by the advertiser are distribution targets.

The advertiser can designate not only some regions or places as distribution targets as desired, but also places all over the country as distribution targets one by one (designate all). In addition, it is also possible to treat places all over the country as the distribution targets by designating a special value as in the embodiment described above. From the above, “only some regions”, “only some places”, and the like or “all over the county”, “regions all over the country”, “places all over the country”, and the like are all “regions set by the advertiser”, and are conceptually included therein.

Table 1 below summarizes a relationship between place setting (“user location” or “predetermined place”) and advertisement distribution control (advertisement distribution on or off and bidding price change).

TABLE 1

| | | Place to Acquire | |
|---|---|---|---|
| | | Meteorological Information | |
| | | | Predetermined |
| | | User Location | Place |
| Control on | Advertisement | A | B-1 |
| Advertisement | Distribution | | |
| Distribution | ON/OFF | | |
| | Change | B-2 | B-3 |
| | Bidding Price | | |
| | | ↓ | ↓ |
| | | Case 1 in (A) | Case 2 in (B) |
| | | of FIG. 1 | of FIG. 1 |
| | | A + B-2 | B-1 + B-3 |

Here, an operation A in Table 1 is as follows.
A: a region where an advertisement is to be or not to be distributed changes depending on whether a meteorological state satisfies a condition. In this case, when the meteorological state at a location of the user satisfies the condition in an advertisement distribution region set by the advertiser, the advertisement is controlled to be distributed only to the location of the user.

Operations B-1, B-2, and B-3 in Table 1 are as follows.
B (common): a region where an advertisement is to be or not to be distributed does not change depending on whether a meteorological state satisfies a condition.
B-1: when the meteorological state (at a predetermined place) satisfies the condition, the advertisement is normally to be distributed to an advertisement distribution region set by the advertiser (when the meteorological state does not satisfy the condition, the advertisement is not to be distributed to any region).
B-2: when the meteorological state (at a location of the user) satisfies the condition, the advertisement is normally to be distributed to an advertisement distribution region set by the advertiser, but a bidding price is to be changed only in an area satisfying the meteorological condition.
B-3: when the meteorological state (at a predetermined place) satisfies the condition, the advertisement is normally to be distributed to an advertisement distribution region set by the advertiser, and a bidding price is to be changed in the entire region where the advertisement is to be distributed.

In the embodiment, the following has been described. That is, there is provided an advertisement management system for requesting distribution of an advertisement from an external advertisement distribution system that distributes the advertisement in a manner of switching depending on a location of a terminal owned by a user who views the advertisement. The advertisement management system requests the advertisement distribution system to distribute or not to distribute an advertisement designated by the advertiser to the terminal in an area in a meteorological state satisfying a meteorological condition set by an advertiser, or to change a bidding price. Accordingly, it is possible to implement a mechanism that distributes an advertisement more suitable for a meteorological state at a location of a user at a distribution target (Case 1 in (A) of FIG. 1).

In the embodiment, the following has also been described. That is, there is provided an advertisement management system for requesting distribution of an advertisement to a terminal owned by a user who views the advertisement, from an external advertisement distribution system that distributes the advertisement in a switching manner. When a predetermined place set by an advertiser is in a meteorological state satisfying a meteorological condition set by the advertiser, the advertisement management system requests the advertisement distribution system to distribute or not to distribute an advertisement designated by the advertiser, or to change a bidding price. Accordingly, it is possible to implement a mechanism that distributes an advertisement for encouraging visits to a specific place such as a leisure facility when a meteorological state at the specific place is good (Case 2 in (B) of FIG. 1).

As described above, according to the embodiment, it is possible to provide a system that distributes a suitable advertisement in conjunction with meteorological information such as the weather, temperature, and precipitation amount. Since personal information of the user as the distribution target is stored by the advertisement distribution system 200 as the external system and is not managed by the advertisement management system 100, a risk of security due to information leakage is reduced.

A case where functions for implementing the invention are recorded in advance in the device has been described in the embodiment, but the invention is not limited thereto, and similar functions may be downloaded to the device from a network, or similar functions stored in a recording medium may be installed in the device. The recording medium may be in any form such as a CD-ROM or a DVD as long as the recording medium can store a program and can be read by the device. The functions obtained by installation or downloading in advance as described above may be implemented in cooperation with an operating system (OS) or the like in the device.

The invention can be implemented in various other forms without departing from the spirit or main features thereof. Therefore, the above-described embodiment is merely an example in every respect, and should not be construed as being limited. The scope of the invention is indicated by the claims, and is not restricted by the text of the specification. Further, all modifications, various improvements, substitutions, and improvements belonging to the equivalent scope of the claims are within the scope of the invention.

### REFERENCE SIGNS LIST

100: advertisement management system
110: web server
120: AP server
120A: job server
120B: job worker
130: DB server
200: advertisement distribution system
300: advertiser terminal
400: advertisement distribution target device
500: meteorological information providing system

1. An advertisement management system for requesting distribution of an advertisement from an external advertisement distribution system that distributes the advertisement in a manner of switching depending on a location of a terminal owned by a user who views the advertisement, wherein
when the terminal is located in an area in a meteorological state satisfying a meteorological condition set by an advertiser, the advertisement management system requests the advertisement distribution system to distribute or not to distribute an advertisement designated by the advertiser to the terminal, or to change a bidding price serving as a reference for determining one advertisement to be distributed among a plurality of advertisements that are candidates for distribution to the terminal.

2. An advertisement management system for requesting distribution of an advertisement from an external advertisement distribution system that distributes the advertisement in a manner of switching depending on a location of a terminal owned by a user who views the advertisement, wherein
the advertisement management system includes
a storage unit configured to store, in association with one another, a meteorological condition set by an advertiser, advertisement identification information for uniquely identifying the advertisement, target place information indicating an area to be determined as to whether the meteorological condition is satisfied, and distinguishing information for distinguishing to distribute or not to distribute the advertisement or to change a bidding price,
a meteorological information acquisition unit configured to acquire, from an external meteorological information providing system, meteorological information at a place to be determined as to whether the meteorological condition is satisfied,
a determination unit configured to determine whether the meteorological information acquired by the meteorological information acquisition unit satisfies the meteorological condition stored in the storage unit, and
an update requesting unit configured to, when the determination unit determines that the meteorological information satisfies the meteorological condition and the terminal is located in the area indicated by the target place information satisfying the condition, request the advertisement distribution system to update setting so as to distribute or not to distribute the advertisement of the advertisement identification information to the terminal according to the distinguishing information, or request the advertisement distribution system to update setting so as to change the bidding price.

3. An advertisement management system for requesting distribution of an advertisement to a terminal owned by a user who views the advertisement, from an external advertisement distribution system that distributes the advertisement in a switching manner, wherein
when a predetermined place set by an advertiser is in a meteorological state satisfying a meteorological condition set by advertiser, the advertisement management system requests the advertisement distribution system to distribute or not to distribute an advertisement designated by the advertiser to a region set by the advertiser, or to change a bidding price serving as a reference for determining one advertisement to be distributed among a plurality of advertisements that are candidates for distribution to the terminal.

4. An advertisement management system for requesting distribution of an advertisement to a terminal owned by a user who views the advertisement, from an external advertisement distribution system that distributes the advertisement in a switching manner, wherein
the advertisement management system includes
a storage unit configured to store, in association with one another, a meteorological condition set by an advertiser, advertisement identification information for uniquely identifying the advertisement, target place information indicating a predetermined place, which is a place set by the advertiser and to be determined as to whether the meteorological condition is satisfied, and distinguishing information for distinguishing to distribute or not to distribute the advertisement or to change a bidding price,
a meteorological information acquisition unit configured to acquire, from an external meteorological information providing system, meteorological information at the predetermined place corresponding to the target place information stored in the storage unit,
a determination unit configured to determine whether the meteorological information acquired by the meteorological information acquisition unit satisfies the meteorological condition stored in the storage unit, and
an update requesting unit configured to, when the determination unit determines that the meteorological information satisfies the meteorological condition, request the advertisement distribution system to update setting so as to distribute or not to distribute the advertisement of the advertisement identification information according to the distinguishing information, or to change the bidding price.

5. The advertisement management system according to claim 3, wherein
the advertisement is an advertisement for encouraging visits to the predetermined place.

6. The advertisement management system according to claim 4, wherein
the advertisement is an advertisement for encouraging visits to the predetermined place.
